(19) United States
(12) Patent Application Publication
(10) Pub. No.: US 2026/0002758 A1
(43) Pub. Date: Jan. 1, 2026

(54) GUN SIGHTING DEVICE INTERACTING WITH SMART GLASSES

(71) Applicant: PENG WANG, Yueyang (CN)

(72) Inventor: PENG WANG, Yueyang (CN)

(21) Appl. No.: 19/315,737

(22) Filed: Sep. 1, 2025

Related U.S. Application Data
(63) Continuation-in-part of application No. 19/283,522, filed on Jul. 29, 2025.
(63) Continuation-in-part of application No. 18/588,596, filed on Feb. 27, 2024, now Pat. No. 12,399,359.

(51) Int. Cl. F41G 1/38; F41G 11/00; G02B 23/16

(52) U.S. Cl. CPC F41G 1/38; F41G 11/003; G02B 23/16

(57) ABSTRACT

A gun sighting device interacting with smart glasses includes a main body and a first communication module. The first communication module is electrically connected to an aiming component. The first communication module is configured for transmitting data collected by the aiming component to smart glasses. The sighting device further includes a mounting base. The mounting base is connected to the main body, and the mounting base is configured for detachably installing the main body on a gun.

### CROSS-REFERENCE TO RELATED APPLICATIONS

This application is a continuation in part of U.S. application Ser. No. 19/283,522, filed on Jul. 29, 2025, which is a continuation of application Ser. No. 18/588,596, filed on Feb. 27, 2024, the content of which is incorporated by reference herein.

### TECHNICAL FIELD

The present invention relates to the field of gun sighting device, in particular to a gun sighting device interacting with smart glasses.

### BACKGROUND ART

With the continuous development of technology, electronic products such as sighting devices are more and more widely used. For instance, the sighting device can be mounted or arranged on various guns, but at present, there are more and more gun models, the sighting device cannot adapt to various types of guns, and the installation method thereof is relatively difficult.

Based on this, it is necessary to provide a brand-new sighting device, which can feed back relevant data collected by the sighting device to the user in real time, thereby greatly improving the user's experience.

### SUMMARY

In order to overcome the shortcomings of the prior art, the present invention provides a gun sighting device, which can achieve efficient and stable connection with various types of guns and significantly improve the flexibility and reliability of installation. At the same time, the sighting device of the present invention can feed back relevant data collected by the sighting device to the user in real time, thereby greatly improving the user's experience.

The technical solution adopted by the present invention to solve the technical problem is as follows.

The present invention provides a gun sighting device. The gun sighting device includes a main body and a mounting base, wherein the main body is provided with an aiming component for sighting and collecting data. The mounting base is connected to the main body, and the mounting base is configured for detachably installing the main body on the gun.

The present invention further provides a sighting device interacting with smart glasses. The sighting device interacting with smart glasses includes a main body and a communication module. The main body is provided with an aiming component for sighting and collecting data. The communication module is electrically connected to the aiming component, and the communication module is configured for transmitting data collected by the aiming component to the smart glasses. The present invention realizes real-time transmission and visualization of the data collected by the sighting device, and greatly improves the user's experience.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a structural schematic diagram of a connection between a sighting device and a pistol;

FIG. 2 is a structural schematic diagram of a connection between the sighting device and the pistol in a first embodiment;

FIG. 3 is a structural schematic diagram of a mounting base in the first embodiment;

FIG. 4 is a structural schematic diagram of another mounting base in the first embodiment;

FIG. 5 is an exploded view of a connection of a sighting device and a rifle in a second embodiment;

FIG. 6 is a structural schematic diagram of a mounting base in the second embodiment;

FIG. 7 is a partial enlarged structural schematic diagram of a portion A in FIG. 5;

FIG. 8 is an exploded view of a first locking member;

FIG. 9 is an exploded view of a connection between a wrench and a lever;

FIG. 10 is a structural schematic diagram of the lever;

FIG. 11 is an exploded view of a connection of a sighting device and a rifle in a third embodiment;

FIG. 12 is an exploded view of a mounting base in the third embodiment;

FIG. 13 is an exploded view of a connection of a sighting device and a rifle in a fourth embodiment;

FIG. 14 is an exploded view of a mounting base in the fourth embodiment;

FIG. 15 is an exploded view of a connection between the main body and the mounting base;

FIG. 16 is an exploded view of a connection between the main body and the mounting base at another angle;

FIG. 17 is a structural schematic diagram of a wireless communication between the sighting device and smart glasses;

FIG. 18 is a structural schematic diagram of a wired communication between the sighting device and the smart glasses;

FIG. 19 is a partial enlarged structural schematic diagram of a portion B in FIG. 18;

FIG. 20 is a structural schematic diagram of a sealing cover;

FIG. 21 is an exploded view of an aiming component and the main body;

FIG. 22 is an exploded view of an objective lens assembly;

FIG. 23 is a structural schematic diagram of the main body;

FIG. 24 is an exploded view of a connection between a second objective lens and a main body in another embodiment;

FIG. 25 is an exploded view of a connection between the second objective lens and a main body in another embodiment.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

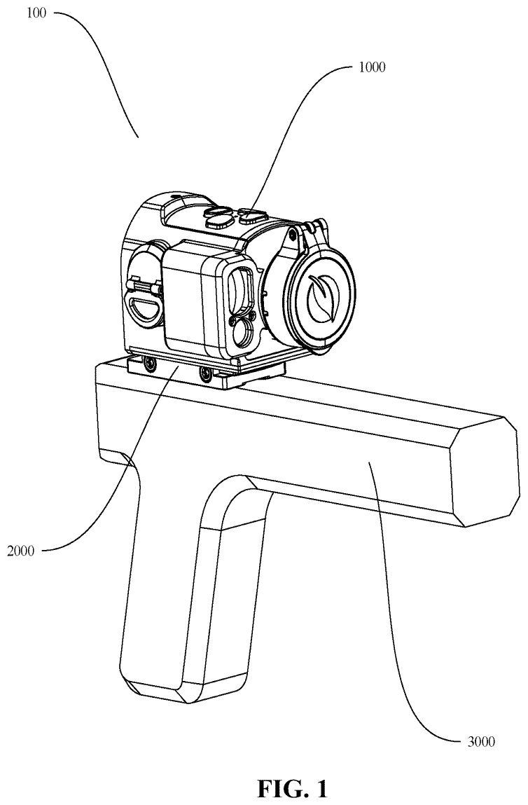

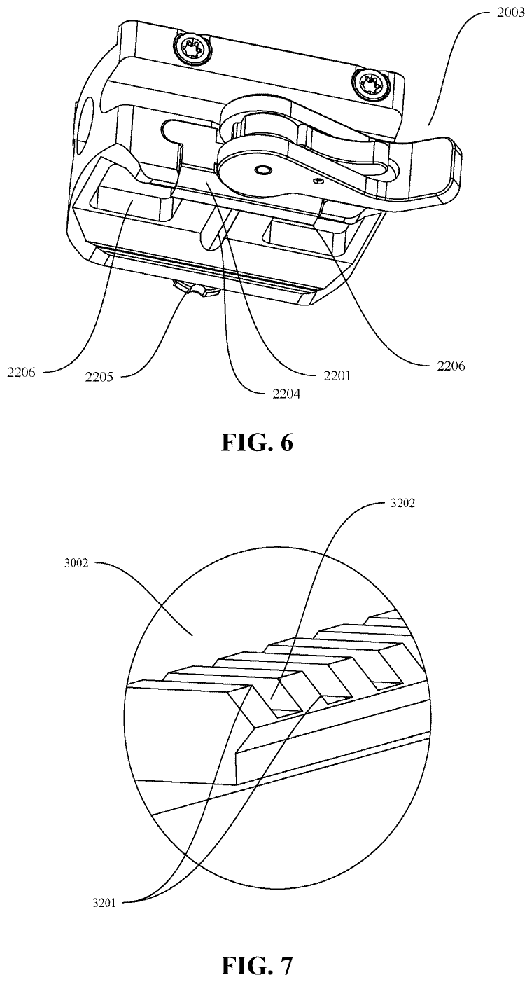

Referring to FIGS. 1-14, a gun sighting device 100 disclosed in the present invention includes a main body 1000 and a mounting base 2000, and an aiming component for sighting and collecting data is provided on the main body 1000. The mounting base 2000 is connected to the main body 1000, and the mounting base 2000 is configured for detachably installing the main body 1000 on the gun 3000. Through the described structural arrangement, the sighting device can be detachably mounted on a pistol via the base. The structure is simple and reliable, facilitating the user to install and detach the sighting device and improving the user's experience.

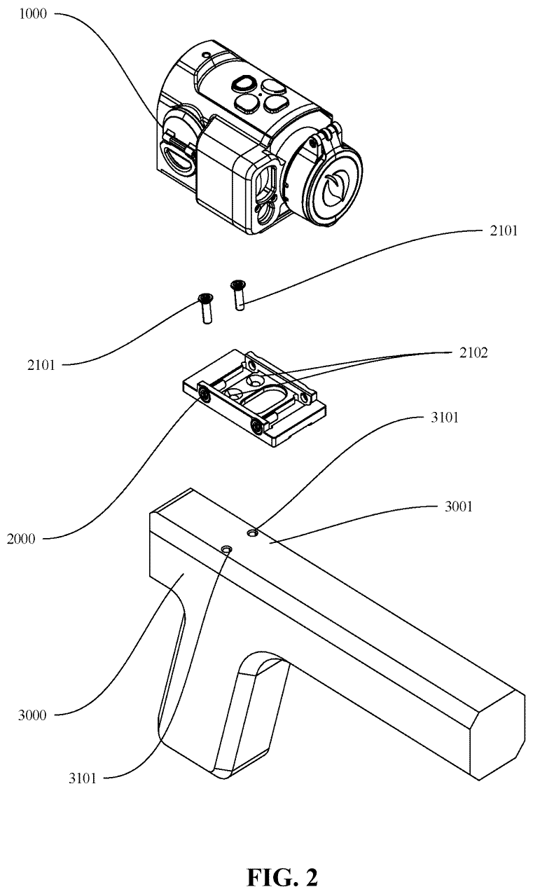

In the first embodiment of the present invention, as shown in FIGS. 2-4, the mounting base 2000 is provided with a first mounting portion 2001, the first mounting portion 2001 is configured for being detachably connected to a second mounting portion 3001 of the gun 3000. The mounting base 2000 of the present embodiment is further provided with a first fixing member 2101, and the first fixing member 2101 is configured for detachably connecting the first mounting portion 2001 with the second mounting portion 3001 of the gun 3000. Through the described structure, the quick alignment and connection of the sighting device and the pistol can be realized, and the connecting reliability can be effectively improved by the fixing of the first fixing member 2101. Preferably, the mounting seat 2000 of the present embodiment is adapted to be detachably connected to the pistol.

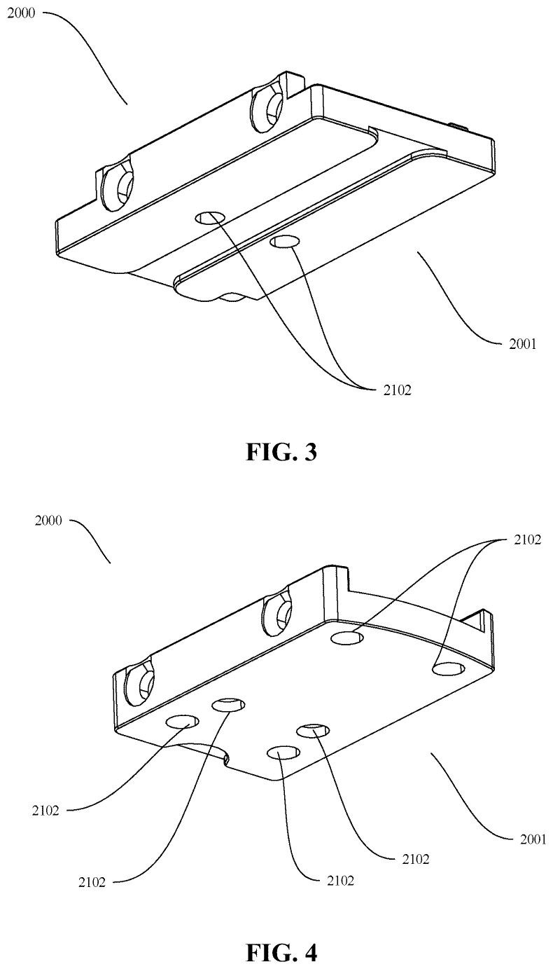

In this embodiment, as shown in FIG. 3, the first mounting portion 2001 includes two first connecting holes 2102, and the two first connecting holes 2102 are arranged respectively on a left side and a right side of the first mounting portion 2001. The first fixing member 2101 is inserted through the first connection hole 2102, and the first fixing member 2101 is configured for being detachably connected to a second connecting hole 3101 of the second mounting portion 3001 of the gun 3000, so that the main body 1000 is detachably mounted on the gun 3000 by the mounting base 2000.

Quite usefully, as shown in FIG. 4, the first mounting portion 2001 includes six first connecting holes 2102, and two first connection holes 2102 are provided at a front end and a rear end of the first mounting portion 2001. Moreover, two first connecting holes 2102 are also provided adjacent to the rear end of the first mounting portion 2001. A corresponding number of second connecting holes 3101 are provided on the second mounting portion 3001 of the gun 3000. The first fixing members 2101 respectively insert through the first connecting holes 2102 and the second connecting holes 3101 to detachably connect the main body to the gun 3000. Through different numbers and positions of the first connecting hole 2102 and the second connecting hole 3101, pistols of different models can be adapted, thereby effectively improving the mounting flexibility of the mounting base 2000 and the universality of the sighting device of the present invention.

Quite usefully, the first fixing member 2101 is a screw, and the first mounting portion 2001 is detachably connected to the second mounting portion 3001 of the gun 3000 through a screw, simplifying the mounting process and ensuring the reliability of the connection.

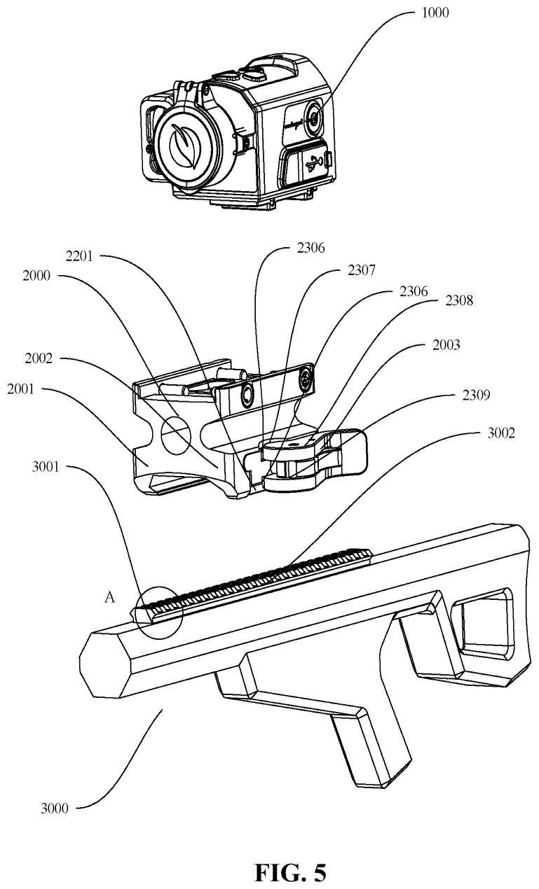

In the second embodiment of the present invention, as shown in FIG. 5, a first mounting portion 2001 is provided on the mounting base 2000, and the first mounting portion 2001 is configured for being detachably connected to a second mounting portion 3001 of the gun 3000. The first mounting portion 2001 includes a first clamping slot 2002, and the first clamping slot 2002 is configured for being detachably connected to the first clamping block 3002 of the gun 3000. Two side walls of the first clamping slot 2002 are clamped by and connected to a side wall of the first clamping block 3002 of the gun 3000. Through the described structure, the first clamping block 3002 is clamped with the first clamping slot 2002, so that the quick disassembly and assembly of the sighting device and the gun are realized, and in particular, the device can be quickly deployed and removed in a tactical environment or an emergency task, thereby improving the operation efficiency. Alternatively, the mounting seat 2000 of the present embodiment is adapted to be detachably connected to a rifle.

In this embodiment, as shown in FIG. 5 to FIG. 8, the first mounting portion 2001 further includes a first locking member 2003, and the first locking member 2003 is configured for locking the first clamping block 3002 of the gun 3000 in the first clamping slot 2002. By providing the first locking member 2003, the stability of the overall connection is also enhanced while the sighting device and the rifle are quickly disassembled and assembled, and the first clamping block 3002 is prevented from loosening or slipping off under a high-frequency vibration, a vigorous exercise or a strong launching environment, thereby improving the usage safety.

In the present embodiment, the side wall of the first clamping slot 2002 is provided with a movable clamping block 2201. The movable clamping block 2201 is provided with a clamping position and a releasing position, and the movable clamping block 2201 is movable between the clamping position and the releasing position. When the movable clamping block 2201 is in the clamping position, the first clamping slot 2002 is configured for being clamped with and connected to the first clamping block 3002 of the gun 3000. When the movable clamping block 2201 moves from the clamping position to the releasing position, the first clamping slot 2002 is configured for releasing the connection with the first clamping block 3002 of the gun 3000. By controlling the movement of the movable clamping block 2201, the controllable locking and quick unlocking of the first clamping block 3002 of the gun 3000 and the first clamping slot 2002 are realized. The operation is simple, furthermore, the operation provides strong clamping, preventing the connection between the first clamping slot 2002 and the first clamping block 3002 from loosening in vibration and impact.

In the present embodiment, the first locking member 2003 abuts against the movable clamping block 2201. The first locking member 2003 is provided with a locking position and an unlocking position, and the first locking member 3 is movable between a locking position and an unlocking position to push the movable clamping block 2201 to move between a clamping position and a releasing position. When the first locking member 2003 moves from the unlocking position to the locking position, the first locking member 2003 pushes the movable clamping block 2201 to move from the releasing position to the clamping position, so that the first clamping slot 2002 is clamped with and connected to the first clamping block 3002 of the gun 3000. When the first locking member 2003 moves from the locking position to the unlocking position, the first locking member 2003 pushes the movable clamping block 2201 to move from the clamping position to the releasing position, so that the first clamping slot 2002 releases the connection with the first clamping block 3002 of the gun 3000. In the above structure, the movable clamping block 2201 can be controlled to move easily by simply operating the first locking member 2003, so as to achieve controllable locking and quick unlocking of the first clamping block 3002 of the gun 3000 and the first clamping slot 2002. During use, the operation time of the user is saved, and the first locking member 2003 cooperates with the movable clamping block 2201 to form a mechanical dual locking, thereby enhancing the overall connection stability. At the same time, the arrangement of the movable clamping block 2201 is more convenient for subsequent replacement and maintenance.

In the present embodiment, the movable clamping block 2201 is an elastic movable clamping block 2201. The first mounting portion 2001 is provided with at least one first mounting cavity 2202. The first mounting cavity 2202 is internally provided with a first elastic member 2203, and the first elastic member 2203 abuts against the movable clamping block 2201. The first elastic member 2203 is configured for moving the movable clamping block from the clamping position to the releasing position with elastic restoring force generated by the first elastic member 2203 when the first locking member 2003 moves from the locking position to the unlocking position. The elastic restoring force generated by the first elastic member 2203 drives the movable clamping block 2201 to rebound from the clamping position to the release position, and the user does not need to manually shift the movable clamping block 2201, thereby simplifying the operation process, significantly shortening the disassembly time, and improving the overall response efficiency, particularly suitable for rapid deployment and recovery scenarios. Preferably, the first elastic member 2203 of the present embodiment is a spring, and a number of the first elastic members 2203 is set to two.

In the present embodiment, the first locking member 2003 includes a first positioning rod 2204 and a wrench 2004 connected to the first positioning rod 2204. A first end of the first positioning rod 2204 inserts through a first side of the first clamping slot 2002 and is fixed and connected by a second fixing member 2205. A second end of the first positioning rod 2204 inserts through a second side of the first clamping slot 2002 and is in transmission connection with the wrench 2004. Through the described structure, the user only needs to rotate or toggle the wrench 2004 to simultaneously drive the first positioning rod 2204 to complete locking or unlocking actions, without disassembling other components, and the operation is simple and quick.

In the present embodiment, a connection through hole is provided on two side walls of the first clamping slot 2002. Two ends of the first positioning rod 2204 are respectively inserted through the connecting through hole. The first end of the first positioning rod 2204 is fixed and connected by the second fixing member 2205, and the second end of the first positioning rod 2204 inserts through the second side of the first clamping slot 2002 and is in transmission connection with the wrench 2004. Preferably, the second fixing member 2205 is a fixing nut, a thread is provided on the first end of the first positioning rod 2204, and the first end of the first positioning rod 2204 is connected to the first side of the first clamping slot 2002 by a threaded connection. Through threaded first positioning rod 2204 connected to the fixing nut in a locking manner and in combination with the transmission structure of the wrench 2004, efficient, precise and reliable mounting of the first locking member 2003 is realized.

In the present embodiment, an inner wall of the first clamping slot 2002 is recessed to form a positioning groove 2206, and the positioning groove 2206 is configured for accommodating the protruding block 3201 of the first clamping block 3002 of the gun 3000. The first positioning rod 2204 is configured for being connected to the positioning slot 3202 formed between adjacent protruding blocks 3201 of the gun 3000. By the connection between the positioning grooves 2206 and the adjacent protruding blocks 3201, it is ensured that each time the first clamping slot 2002 is accurately positioned with the first clamping block 3002 of the gun 3000.

In the present embodiment, the wrench 2004 includes a rotating end 2301 and an operating handle 2302, and the rotating end 2301 is in transmission connection with the first positioning rod 2204 by a rotating assembly 2303. The rotating assembly 2303 includes a first rotating shaft 2304 and a rotating cam 2305. The rotating cam 2305 is connected to the first positioning rod 2204, and the first rotating shaft 2304 penetrates through the rotating cam 2305 and is connected to two ends of the wrench 2004. Through the described structure, friction and jamming between the wrench 2004 and the first mounting portion 2001 are reduced, improving transmission efficiency and response speed, so as to achieve a quick locking and unlocking process. Preferably, two ends of the wrench 2004 are provided with connection through holes, and the first rotating shaft 2304 penetrates the rotating cam 2305 and extends outward into the connection through holes at both ends of the wrench 2004.

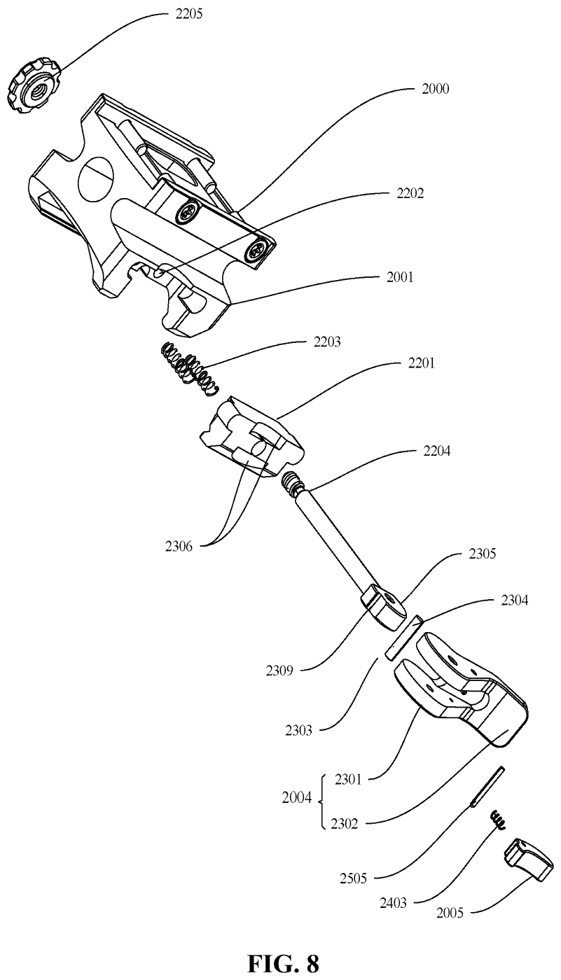

In this embodiment, as shown in FIG. 8, an outer side of the movable clamping block 2201 is provided with an avoidance groove 2306. A first side of the rotating end 2301 is provided in the avoidance groove 2306, and the rotating end 2301 is provided with a first pivot 2307 in contact with the avoidance groove 2306 and a second pivot 2308 opposite to the first pivot 2307. A distance between the first pivot 2307 and the first rotating shaft 2304 is greater than a distance between the second pivot 2308 and the first rotating shaft 2304. The rotating end 2301 is eccentrically arranged, and the eccentric rotating end 2301 enables the first pivot 2307 to generate a greater clamping force during the locking process, so that the first pivot 2307 can achieve a more reliable and stable connection during fast clamping.

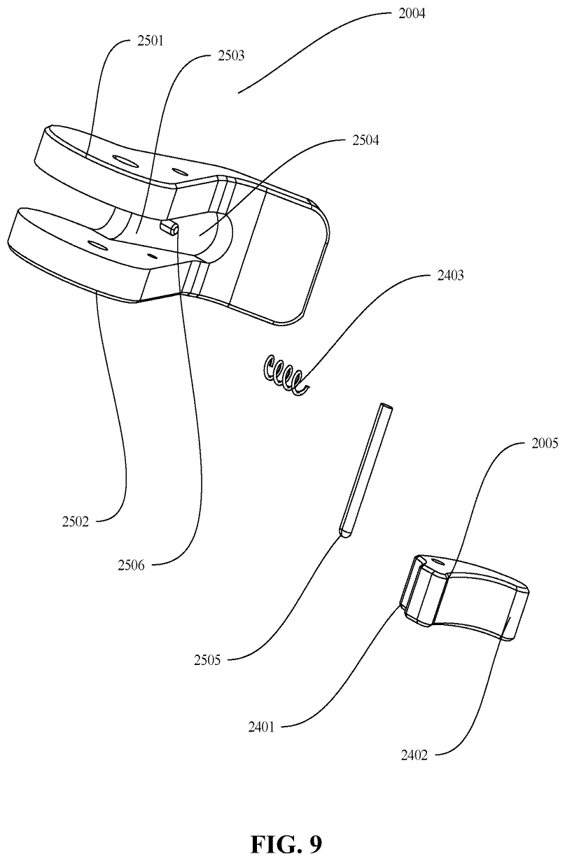

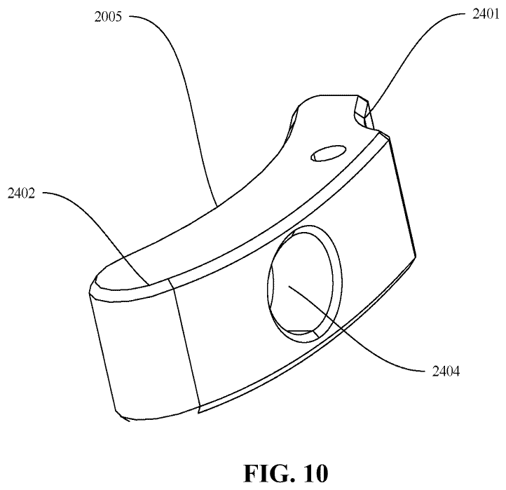

In this embodiment, as shown in FIG. 9 to FIG. 10, the first locking member 2003 further includes a lever 2005, and the lever 2005 is configured to lock or unlock the wrench 2004. A first end of the lever 2005 is arranged in the wrench 2004, and is hinged to the wrench 2004. Specifically, the wrench 2004 is provided with a first side wall 2501, a second side wall 2502, and a bottom wall 2503. Two ends of the first rotating shaft 2304 are respectively provided on the first side wall 2501 and the second side wall 2502, and a second mounting cavity 2504 is formed between the first side wall 2501, the second side wall 2502 and the bottom wall 2503. The lever 2005 is arranged in the second mounting cavity 2504, and is hinged to the wrench 2004 via a second rotating shaft 2505. Through the described structure, not only a stable mounting space is provided for the lever 2005, but also the movement trajectory of the lever 2005 can be effectively limited, thereby reducing shaking and errors. Additionally, the lever 2005 is hingedly connected to the wrench 2004 via the second rotating shaft 2505, ensuring that the lever 2005 can rotate reliably inside the wrench 2004 and enhancing the control performance thereof.

In the present embodiment, the first end of the lever 2005 is provided with a locking block 2401. An outer wall of the rotating cam 2305 is provided with a locking groove 2309. When the locking block 2401 is provided in the locking groove 2309, the lever 2005 locks the wrench 2004. When the locking block 2401 is away from the locking groove 2309, the lever 2005 unlocks the wrench 2004. The locking block 2401 is embedded in the locking groove 2309 to form a stable fixing point, which can effectively prevent the wrench 2004 from accidental loosening, improve use safety, and help resist loosening caused by impact or vibration of an external force.

In the present embodiment, the second end of the lever 2005 is provided with a pressing portion 2402. The pressing portion 2402 is pressed, so that the locking block 2401 is away from the locking groove 2309, and at this time, the lever 2005 unlocks the wrench 2004, enabling the wrench 2004 to move between the locking position and the unlocking position. When the wrench 2004 moves from the locking position to the unlocking position, and when the lever 2005 moves with the wrench 2004 until the locking block 2401 approaches the locking groove 2309, the pressing portion 2402 is released, allowing locking block 2401 to fall into locking groove 2309 to lock wrench 2004. By providing the pressing portion 2402, the user can unlock the wrench 2004 through a simple pressing operation without needs for complicated actions or tool assistance. Moreover, the design of the lever 2005 moving with the wrench 2004 and the locking block 2401 automatically approaching the locking groove 2309 ensures that the locking of the wrench 2004 during the movement is natural and smooth without a need for manual alignment.

In the present embodiment, a second elastic member 2403 is arranged between the lever 2005 and a bottom wall 2503. A connecting column 2506 is arranged on the bottom wall 2503. A guiding installation hole 2404 is arranged on an inner side of the lever 2005. A first end of the second elastic member 2403 is sleeved on the connecting column 2506, and a second end of the second elastic member 2403 is arranged in the guiding installation hole 2404. The second elastic member 2403 is configured for generating an elastic restoring force to make the locking block 2401 of the lever 2005 away from the locking groove 2309 when the lever 2005 is released. By providing the second elastic member 2403, the user does not need to manually return the lever 2005, thereby effectively improving the operation efficiency and comfort. Preferably, the second elastic member 2403 is a spring.

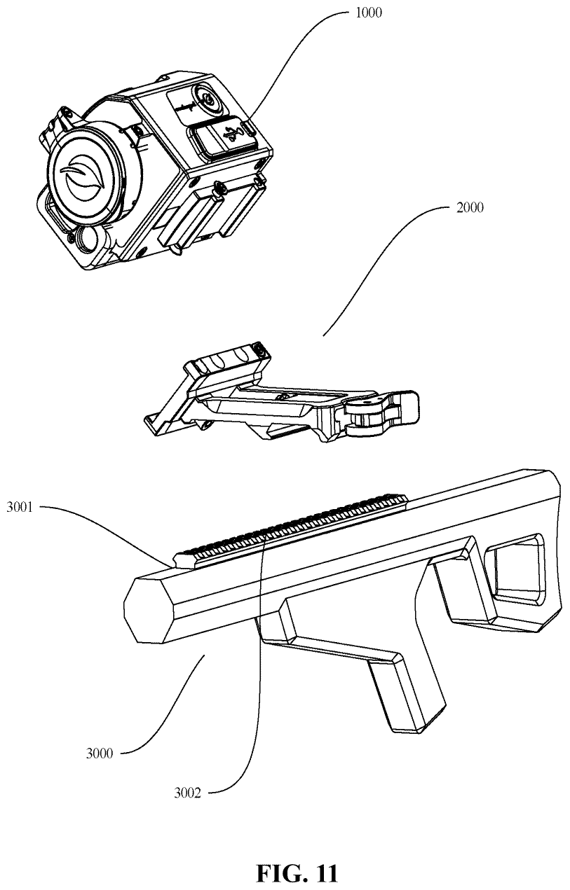

In a third embodiment of the present invention, as shown in FIG. 11, the sighting device further includes a first mounting bracket 1001. A first end of the first mounting bracket 1001 is detachably connected to the mounting base 2000, and a second end of the first mounting bracket 1001 is provided with a first mounting portion 2001. The first mounting bracket 1001 is set at an inclined angle to the mounting seat 2000. The inclined mounting bracket 1001 moves forward or lifts the sighting device to effectively adjusts the relative position between the optical axis of the sighting device and the barrel ray, reducing the neck fatigue generated by the user due to the pitch line of sight. In addition, the first mounting bracket 1001 arranged at an oblique angle can prevent the sighting device from interfering with components such as a forend, a magazine, an ejector, etc. thereby increasing the mounting space.

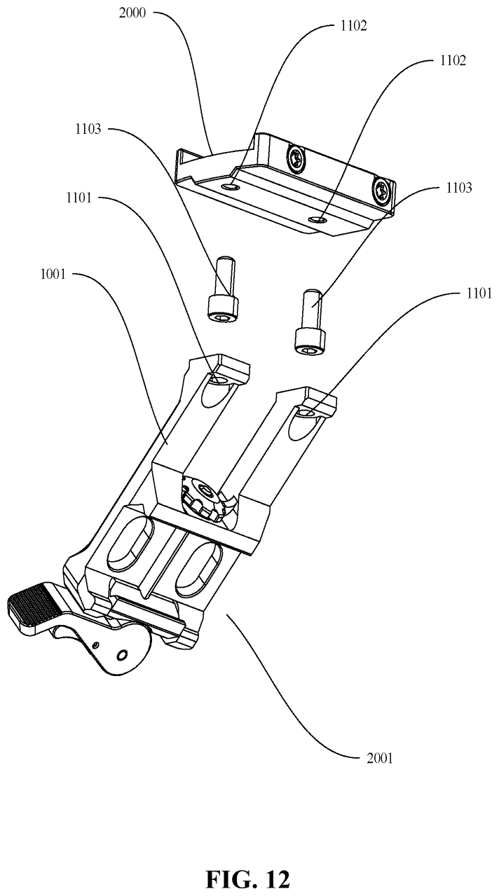

In this embodiment, as shown in FIG. 12, a first end of the first mounting bracket 1001 is provided with a first connecting portion 1101. A bottom of the mounting base 2000 is provided with a second connecting portion 1102. The first connecting portion 1101 and the second connecting portion 1102 are detachably connected by a third fixing member 1103. Preferably, the first connecting portion 1101 and the second connecting portion 1102 are both screw holes, and the third fixing member 1103 is a screw. Through the described method, the first mounting bracket 1001 is mounted on the mounting base 2000, providing a simple operation and a more stable connection.

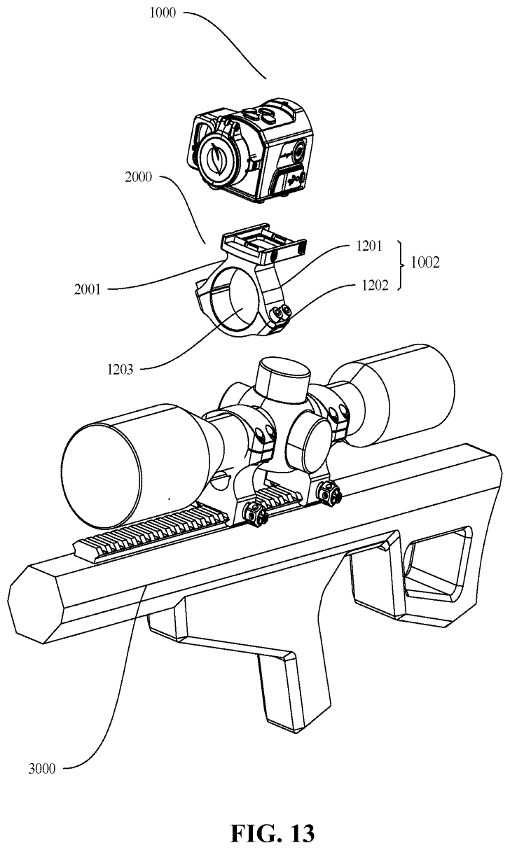

In the fourth embodiment of the present invention, as shown in FIG. 13, the sighting device further includes a second mounting bracket 1002. The second mounting bracket 1002 is connected to the mounting base 2000. The second mounting bracket 1002 includes a first bracket 1201 and a second bracket 1202 detachably connected to the first bracket 1201. The first bracket 1201 and the second bracket 1202 surround to form a third mounting cavity 1203, and the third mounting cavity 1203 is configured for being detachably connected to a scope of the gun 3000. Preferably, the first bracket 1201 and the second bracket 1202 are each provided with an arc-shaped structure, and the first bracket 1201 and the second bracket 1202 surround to form a third mounting cavity 1203 of an arc-shaped column, so as to better adapt to the tubular structure of the scope.

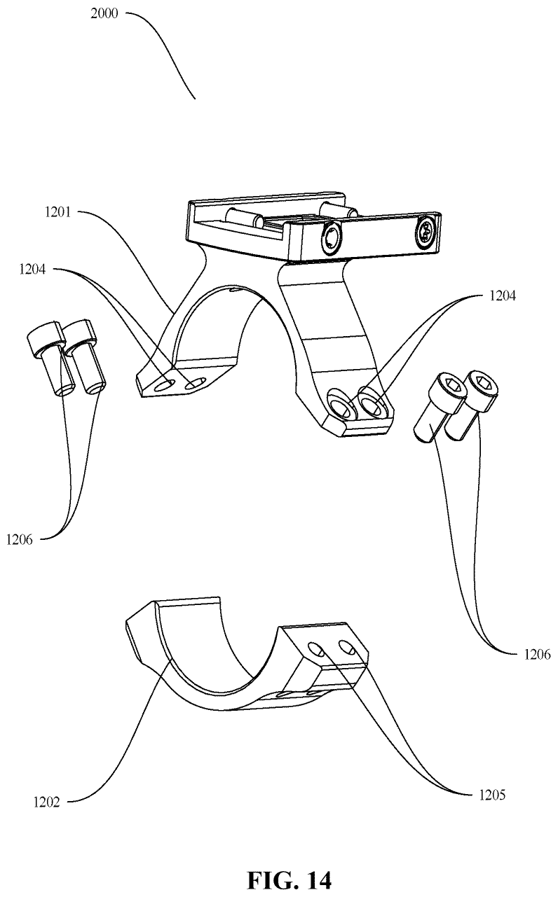

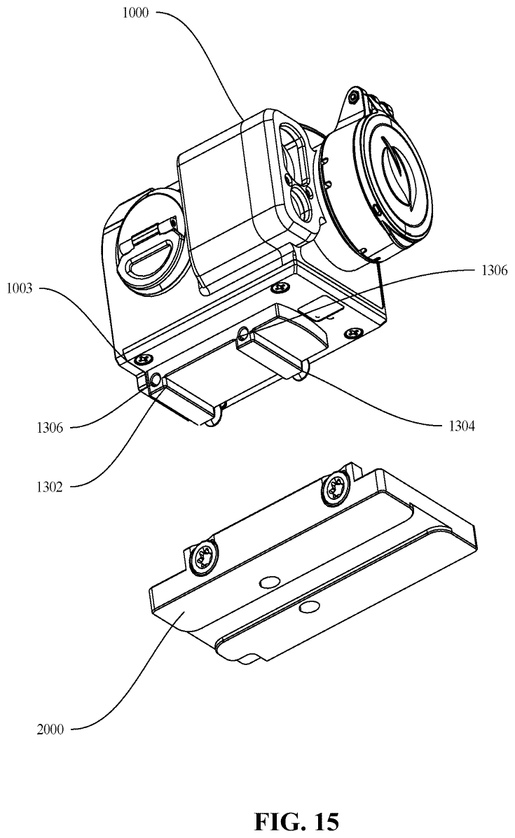

In this embodiment, as shown in FIG. 14, the first bracket 1201 is provided with a third connecting portion 1204, and the second bracket 1202 is provided with a fourth connecting portion 1205. The third connecting portion 1204 and the fourth connecting portion 1205 are detachably connected by a fourth fixing member 1206. Preferably, both the third connecting portion 1204 and the fourth connecting portion 1205 are threaded holes. The fourth fixing member 1206 is a screw. The first bracket 1201 and the second bracket 1202 are detachably connected via screw connection, providing a simple operation and a more stable connection.

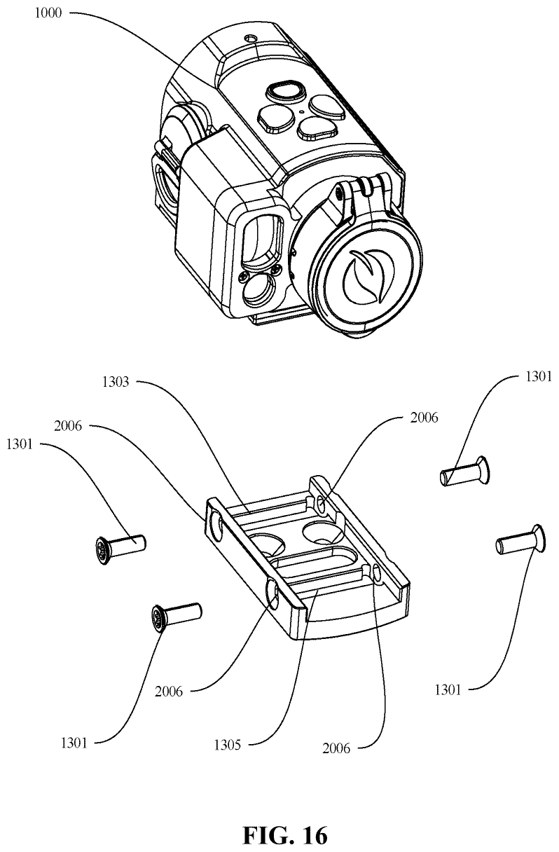

As shown in FIGS. 15-16, the main body 1000 of the present invention is provided with a mounting block 1003. The mounting seat 2000 is detachably connected to the mounting block 1003 and the connection thereof is fastened by a fifth fixing member 1301. The mounting block 1003 is provided with at least one first protruding block 1302, and the mounting seat 2000 is provided with at least one first receiving slot 1303 corresponding to the first protruding block 1302, and the first protruding block 1302 is arranged in the first receiving slot 1303. After the first protruding block 1302 is inserted into the corresponding first receiving slot 1303, the centering of the predetermined position is automatically realized, and the positioning error in the assembly process is eliminated.

Preferably, the mounting block 1003 is further provided with at least one second protruding block 1304. The mounting seat 2000 is provided with at least one second receiving slot 1305 corresponding to the second protruding block 1304, and the second protruding block 1304 is arranged in the second receiving slot 1305, and is fixed by the fifth fixing member 1301. By adding the second protruding block 1304 and the second receiving slot 1305, the assembly process is more accurate.

In the present embodiment, the first protruding block 1302 and the second protruding block 1304 are respectively arranged at two ends of the mounting block 1003, and both ends of the first protruding block 1302 and the second protruding block 1304 are provided with a fifth connecting portion 1306. The mounting seat 2000 is provided with a sixth connecting portion 2006, and the fifth fixing members 1301 are sequentially arranged in the fifth connecting portion 1306 and the sixth connecting portion 2006, so that the mounting seat 2000 is connected to the main body 1000. Preferably, the fifth connecting portion 1306 is a screw hole, the fifth fixing member 1301 is a screw, and the main body 1000 and the mounting base 2000 are detachably connected by screw connection, providing a simple operation and a more stable connection.

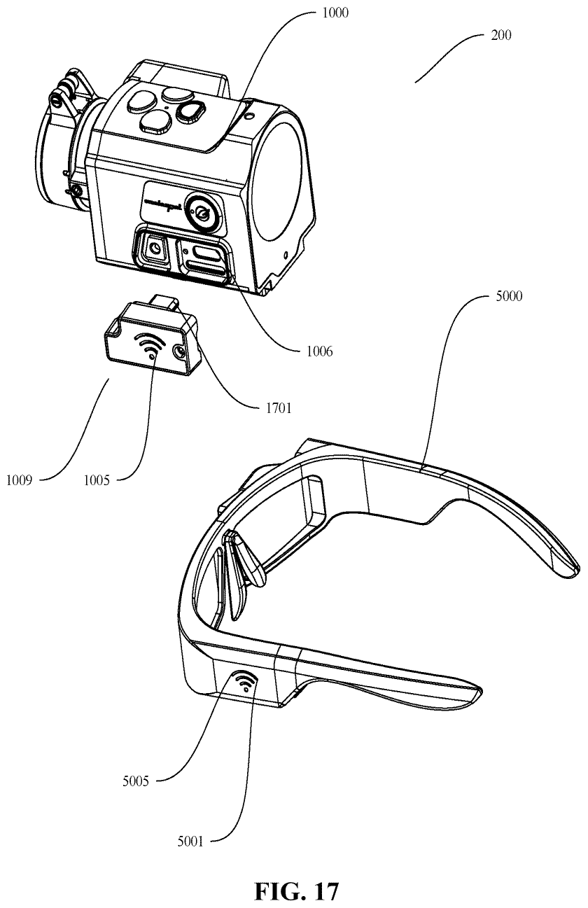

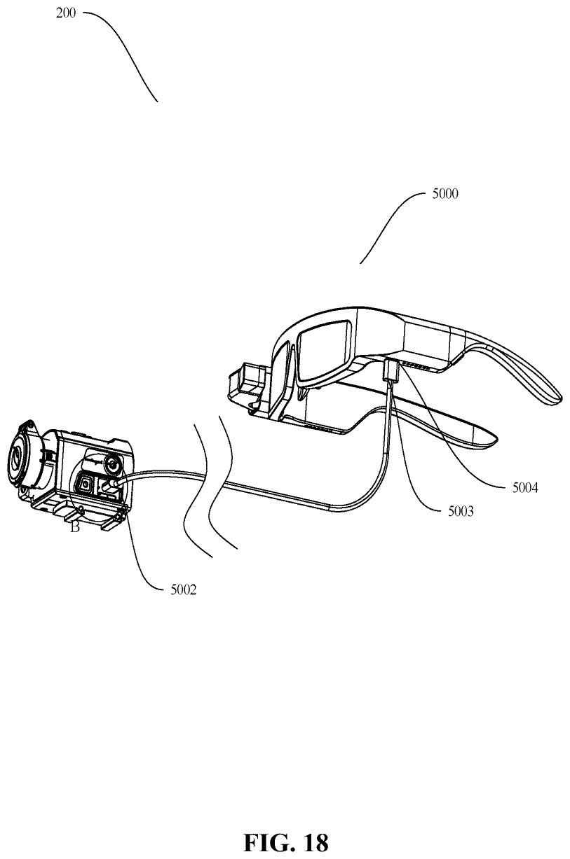

The present invention further provides a sighting device interacting with smart glasses 200, as shown in FIGS. 17 and 18. The sighting device interacting with smart glasses 200 includes a main body 1000 and a first communication module. The main body 1000 is provided with an aiming component for sighting and collecting data. The first communication module is electrically connected to the aiming component, and the first communication module is configured for transmitting data collected by the aiming component to smart glasses.

In this embodiment, the first communication module is a wireless communication module. The present embodiment not only achieves wireless real-time transmission and visualization of sighting data, but also greatly improves the user's experience.

Specifically, as shown in FIG. 17, the wireless communication module includfes a first wireless communication module 1005 provided on the main body 1000, and the first wireless communication module 1005 is electrically connected to the main body 1000. The first wireless communication module 1005 is configured for transmitting data collected by the aiming component to a second wireless communication module 5001 of the smart glasses 5000. By arranging the first wireless communication module and the second wireless communication module to form a dedicated communication channel, mutual influences with other devices or external radio frequency interference sources are avoided.

As another embodiment of the present invention, as shown in FIG. 18, the first communication module is a wired communication module. The wired connection is not affected by radio wave interference or signal blocking, and can maintain stable communication in a complex electromagnetic environment.

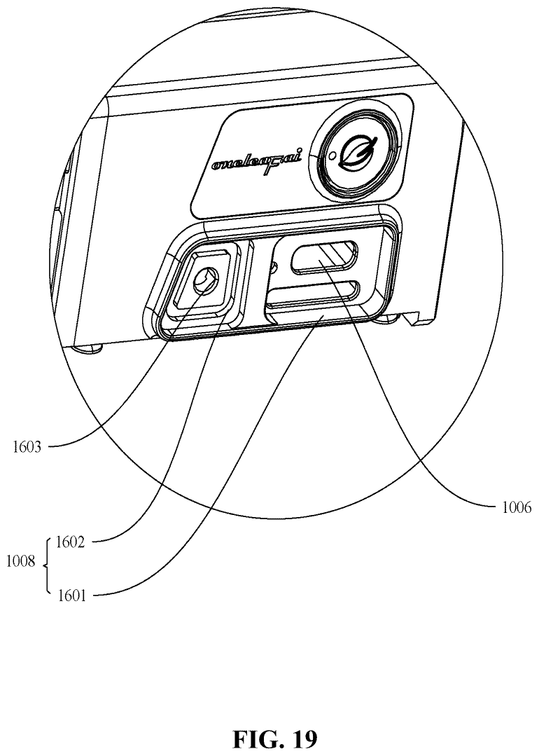

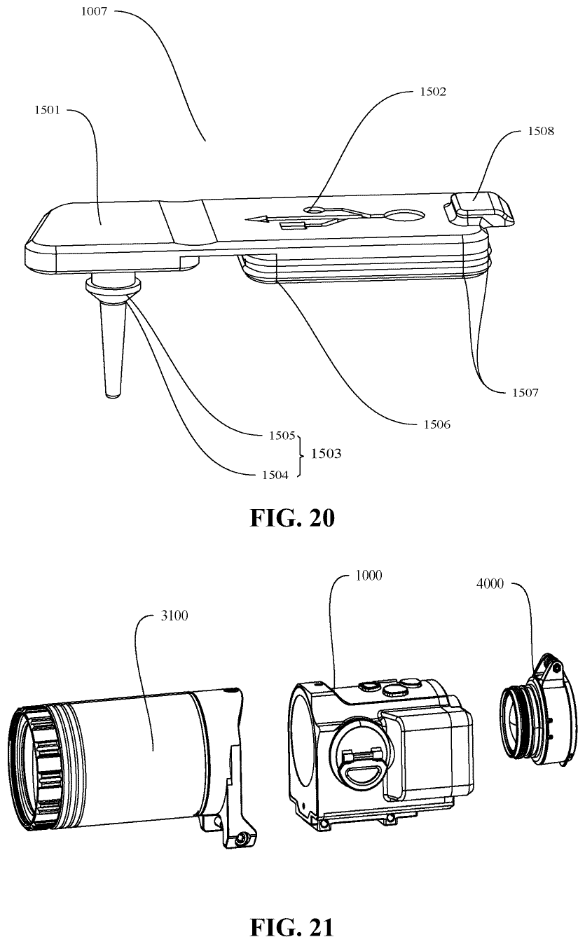

Specifically, as shown in FIGS. 19 and 20, the wired communication module is provided with a first connection end 5002 and a second connection end 5003. The first connection end 5002 is electrically connected to the main body 1000, and the second connection end 5003 is configured for being electrically connected to the smart glasses 5000. The main body 1000 is provided with a first interface 1006, and the first interface 1006 is electrically connected to the first connection end 5002. The second connection end 5003 is configured for being electrically connected to a second interface 5004 of the smart glasses 5000. The wired direct connection manner supports high-speed signal transmission, reduces delay in data packing and unpacking processes, and enables the user to obtain millisecond-level real-time feedback during sighting and shooting decisions. The first interface 1006 and the second interface 5004 of the present embodiment can flexibly adapt to a variety of interface types, such as USB-C, HDMI, DC interfaces, etc. meeting connection requirements of different devices.

In the present embodiment, the main body 1000 further includes a sealing cover 1007. The main body 1000 is provided with a connection port 1008. The sealing cover 1007 detachably covers the connection port 1008. The sealing cover 1007 covers the connection port 1008, so that the sealing cover 1007 prevents dust, sand particles and water mist from entering the interior, thereby effectively improving the environmental adaptability and service life of the device. Preferably, the sealing cover 1007 of the present embodiment is a flexible sealing cover.

In the present embodiment, the connection port 1008 is provided with a first slot 1601 and a second slot 1602 arranged side by side with the first notch 1601. The first slot 1601 is provided with a first interface 1006. The sealing cover 1007 is provided with a third connection end 1501 and a sealing end 1502. The third connection end 1501 is connected to the second slot 1602. The sealing end 1502 is set in and covers on the first slot 1601, so as to seal the first slot 1601. A first interface 1006 is arranged on the first slot 1601. The second slot 1602 is configured for fixing or assisting the cable arrangement of the cover 1007. The first slot 1601 and the second slot 1602 are designed separately and do not interfere with each other. Moreover, the third connection end 1501 of the sealing cover 1007 is inserted into the second slot 1602, such that the position of the sealing cover 1007 is locked, and the sealing cover 1007 is always kept connected to the main body 1000 during disassembly and assembly processes.

In the present embodiment, an inner wall of the second slot 1602 is provided with a connection hole 1603. The third connection end 1501 is provided with a connecting rod 1503, the connecting rod 1503 is inserted into the connection hole 1603, so that the sealing cover 1007 is connected to the main body 1000. The connecting rod 1503 is provided with an plug-in end 1504, and the plug-in end 1504 is inserted into the connection hole 1603. A clamping block 1505 is provided between a top end of the plug-in end 1504 and a side wall of the connection hole 1603. The clamping block 1505 is configured for clamping the plug-in end 1504 into the connection hole 1603 tightly, so that the sealing cover 1007 is sealingly connected to the main body 1000. Additionally, a diameter of the plug-in end 1504 gradually increases from a bottom end to a top end. Through the described structure, when the plug-in end 1504 is inserted into the connection hole 1603, the clamping block 1505 abuts against the side wall of the connection hole 1603, so that the sealing cover 1007 is limited and mounted to the main body 1000, and a stable and reliable mounting effect is provided between the sealing cover 1007 and the main body 1000.

In the present embodiment, the sealing end 1502 is provided with a sealing portion 1506 for sealing the first slot 1601, and at least one sealing gasket 1507 is further provided on an outer wall of the sealing portion 1506. Through providing the sealing gasket 1507, water vapor, dust and particulate intrusion can be effectively prevented.

In the present embodiment, an outer surface of the sealing cover 1007 is provided with an operation protrusion 1508. The operation protrusion 1508 is configured for driving the sealing portion to move when the operation protrusion 1508 is pulled by an external force, so that the seal between sealing part 1506 and first slot 1601 is released.

In the present embodiment, the first wireless communication module 1005 is detachably connected to the first interface 1006 of the main body 1000, and the first wireless communication module 1005 is electrically connected to the first interface 1006 of the main body 1000. The first wireless communication module 1005 can be freely assembled and disassembled via the first interface 1006, so that the first wireless communication module 1005 can be replaced and upgraded without disassembling the entire device. Moreover, the first interface 1006 electrically connected to the first wireless communication module 1005 ensures the integrity and response speed of the data transmission, without delay or packet loss.

In the present embodiment, the main body 1000 further includes a first control box 1009, and the first control box 1009 is provided with a plug connector 1701. The plug connector 1701 is electrically connected to the first interface 1006. The first wireless communication module 1005 is provided in the first control box 1009, and the first wireless communication module 1005 is electrically connected to the plug connector 1701. The first wireless communication module 1005 is packaged in the first control box 1009 to form a structurally independent and easily replaced functional unit. When a fault occurs or it needs to be upgraded, the first control box can be directly replaced without disassembling other parts of the main body 1000, thereby improving the maintenance efficiency.

In this embodiment, the main body 1000 is internally provided with a power supply device, and the power supply device is electrically connected to the first interface 1006.

The sighting device of the present invention further includes smart glasses 5000, and a second control box 5005 is provided on the smart glasses 5000. The second wireless communication module 5001 is provided in the second control box 5005 and is in communication connection with the first wireless communication module 1005. Herein, the smart glasses further include a camera, a data processing module, a display module, a power supply module, and a touch module. The camera, the data processing module, the display module, and the touch module are all electrically connected to the power module. The data processing module is configured for sending the sighting position and the target image received from the scope into the smart glasses 5000, and the display module is configured for displaying the sighting position and the target image. In this case, the smart glasses 5000 displays the picture captured by the first objective lens 4001 and the UI icon displayed on the screen, and the user can further modify the display mode of the main body 1000 and a type and a color of the UI icon by the touch module.

In the present embodiment, as shown in FIG. 21, the aiming component includes an eyepiece assembly 3100 and an objective lens assembly 4000. The objective lens assembly 4000 is detachably arranged at a front end of the main body 1000 and is in electrical communication with the main body 1000. The objective lens assembly 4000 is configured for sighting and collecting an optical signal of a target object. The eyepiece assembly 3100 is detachably arranged at a rear end of the main body 1000 and is electrically connected to the main body 1000. The eyepiece assembly 3100 is configured for receiving and amplifying the optical signal collected from the objective lens assembly 4000. The eyepiece assembly 3100 and the objective lens assembly 4000 are both detachably connected to the main body 1000, so that the user can replace the eyepiece assembly 3100 and the objective lens assembly 4000 according to different requirements.

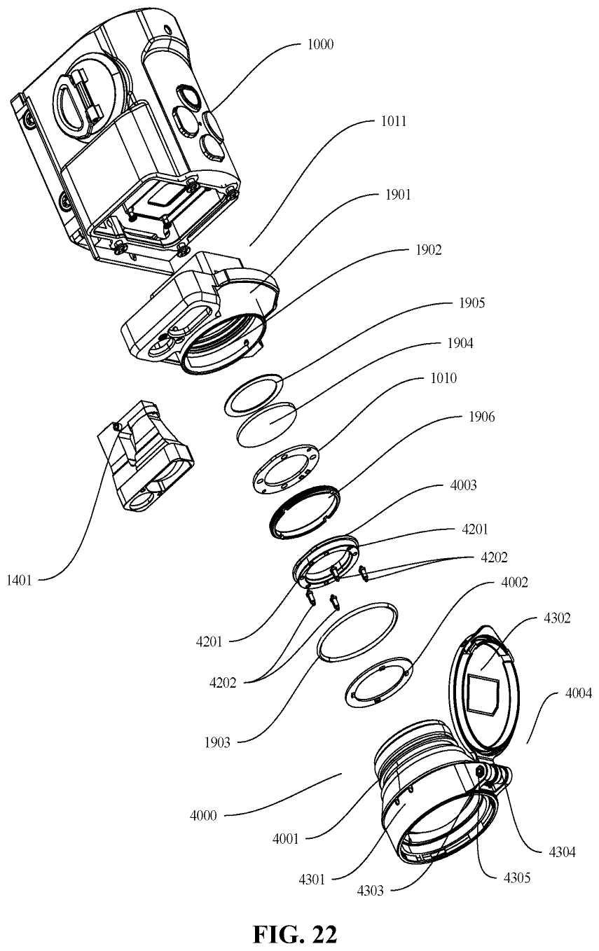

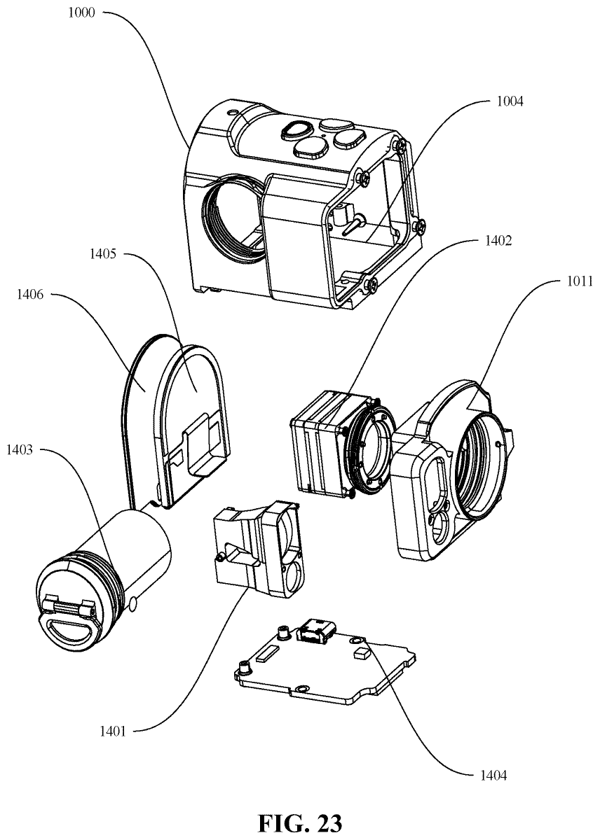

In this embodiment, as shown in FIG. 22, the aiming component includes an objective lens assembly 4000, and the objective lens assembly 4000 includes an objective lens assembly 4000. A first end of the main body 1000 is provided with a first electrical connection board 1010. A first end of the first objective lens 4001 is provided with a second electrical connection board 4002. The first electrical connection board 1010 is electrically connected to the second electrical connection board 4002, and the objective lens 4001 is electrically connected to the main body 1000. The objective lens assembly 4000 further includes a mounting frame 4003, and a plurality of through holes 4201 are provided on the mounting frame 4003. A conductive contact 4202 is mounted in the through hole 4201, and two ends of the conductive contact 4202 respectively abut against the first electrical connection board 1010 and the second electrical connection board 4002, so that the first electrical connection board 1010 is electrically connected to the second electrical connection board 4002. Through the two ends of the conductive contact 4202 directly abutting against the first electrical connection board 1010 and the second electrical connection board 4002, a low-impedance high-quality electrical signal transmission path is provided, and the conductive contact 4202 arranged in the through hole 4201 of the mounting frame is of good stability and sealing properties. In other embodiments, the conductive contact is designed with an elastic or gold-boarded material with good contact pressure and abrasive resistance, suitable for high-frequency plugging and long-term use requirements.

In the present embodiment, a first end of the main body 1000 is provided with a mounting portion 1011, and the mounting portion 1011 is provided with a housing 1901. An inner wall of the housing 1901 surrounds a mounting slot 1902. A first end of the first objective lens 4001 is detachably arranged in the mounting slot 1902. A first waterproof gasket 1903 is provided between the first objective lens 4001 and an inner wall of the mounting slot 1902. The first waterproof gasket 1903 arranged between the first objective lens 4001 and the inner wall of the mounting slot 1902 effectively blocks rainwater, moisture and dust from entering the lens.

In this embodiment, the mounting slot 1902 is further provided with a germanium window 1904. The germanium window 1904 is configured to prevent dust from entering the thermal imaging detector in the main body 1000. The germanium window 1904 is of excellent infrared transmittance and mechanical strength, and the germanium window 4 is used as a dust-proof window to effectively filter the particle pollutant without interfering with optical acquisition.

In the present embodiment, a second waterproof gasket 1905 is arranged between the germanium window 1904 and a bottom end of the housing 1. The second waterproof gasket 1905 is arranged between the germanium window 1904 and the bottom end of the housing 1 to close a channel below the first objective lens 4001, forming a double protective structure suitable for desert, rainforest, and high-humidity combat environments.

In the present embodiment, the mounting slot 1902 is further provided with a limiting mounting member 1906 for positioning the mounting frame 4003, so that the objective lens assembly 4000 can be quickly aligned and fixed, and the imaging deviation caused by an assembly error can be avoided.

In the present embodiment, as shown in FIG. 22, an objective lens cover 4004 is also covered on the first objective lens 4001. The objective lens cover 4004 includes a sealed cover seat 4301, and a lens cover 4302 hinged to the sealed cover seat 4301. The lens cover 4302 is sleeved at a first end of the first objective lens 4001. The sealed cover seat 4301 is provided with a hinge base 4303 and a hinge portion 4304. The hinge portion 4304 is arranged in the hinge base 4303 and is hinged by a hinge shaft 4305. Through the described structure, the objective lens cover 4004 can be quickly opened and closed.

In this embodiment, as shown in FIG. 23, the main body 1000 is provided with an accommodating cavity 1004, and the accommodating cavity 1004 is internally provided with a ranging module 1401, a thermal imaging detector 1402, a power supply device 1403 and a circuit board 1404. The thermal imaging detector 1402, the ranging module 1401, and the circuit board 1404 are all electrically connected to the power supply device 1403. The thermal imaging detector 1402 is configured for receiving a target surface radiated heat and generating a thermal image. The ranging module 1401 is configured for measuring a distance to a target object. The main body 1000 is internally provided with a display screen 1405 and a touch screen 1406. The display screen 1405 and the touch screen 1406 are sequentially arranged from inside to outside and are both electrically connected to the power supply device 1403. The display screen 1405 is configured for displaying the target object, and the touch screen 1406 is configured for touching the operation control scope to work. Preferably, the thermal imaging detector 1402 is a vanadium oxide detector device.

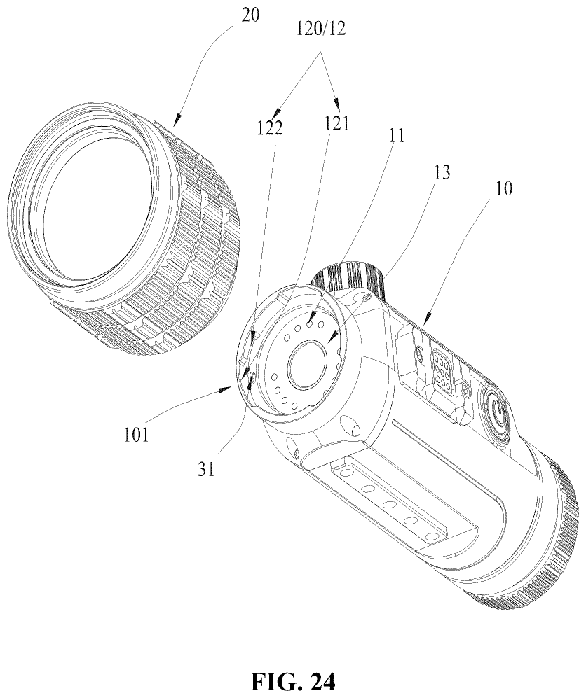

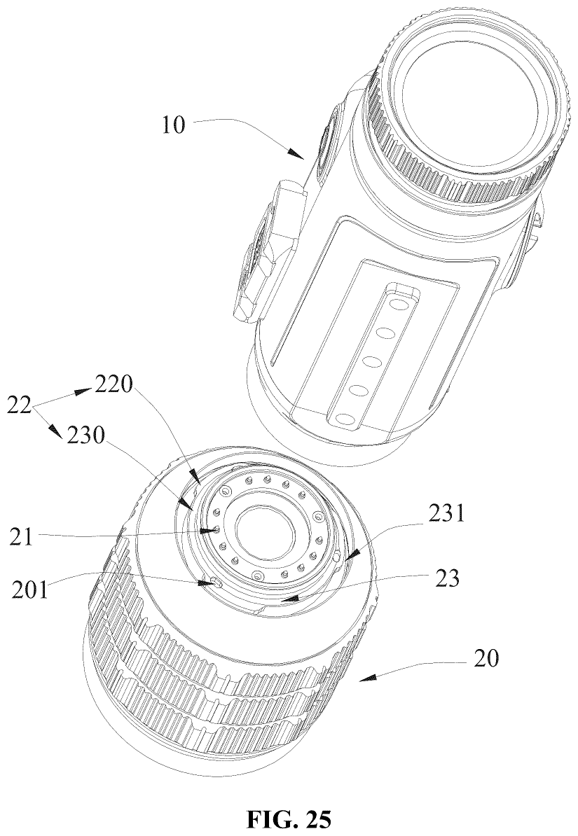

The present invention further provides a scope, as shown in FIGS. 24 to 25, the scope includes a sight main body 10. The sight main body 10 includes a fourth connection end 101. An end face of the fourth connection end 101 of the sight main body 10 is provided with a first electrical connection assembly 11, and a first engagement member 12 is arranged around the first electrical connection assembly 11. A second engagement member 22 is arranged around a second electrical connection assembly 21. The second engagement member 22 can be clamped into the first engagement member 12, so that the second objective lens 20 is detachably connected to the sight main body 10, and when the second engagement member 22 is clamped into the first engagement member 12, the second electrical connection assembly 21 abuts against the first electrical connection assembly 11, so that the second objective lens 20 is electrically connected to the sight main body 10.

In the present embodiment, the end face of the fourth connection end 101 of the sight main body 10 is provided with a first notch 13. The first electrical connection assembly 11 and the first engagement member 12 are both arranged in the first notch 13. An end face of an end of the second objective lens 20 connected to the sight main body 10 is provided with a second notch 23. The second engagement member 22 and the second electrical connection assembly 21 are both arranged in the second notch 23. When the second objective lens 20 is mounted on the sight main body 10, the second notch 23 wraps the first notch 13 or the first notch 13 wraps the second notch 23.

In the present embodiment, the first engagement member 12 includes an engagement interface 120. The engagement interface 120 is arranged on a side wall of the first notch 13. The second engagement member 22 includes an second objective lens clamping block 220 and a mounting column 230. Two ends of the mounting column 230 are communicated, and the mounting column 230 is arranged in the second notch 23. The second electrical connection assembly 21 is arranged in through holes of the mounting column 230. The second objective lens clamping block 220 is arranged around an outer side of the mounting column 230. A gap 231 is stored between an end of the second objective lens clamping block 220 and a side wall of the second notch 23. The gap 231 can accommodate the side wall of the first notch 13. When the second objective lens 20 is mounted on the sight main body 10, the side wall of the first notch 13 is mounted in the gap 231, and the second notch 23 wraps the first notch 13. Or the first engagement member 12 includes the second objective lens clamping block 220 and the mounting column 230. The two ends of the mounting column 230 are in communication. The mounting column 230 is arranged in the first notch 13. The second objective lens clamping block 220 is arranged around the outer side of the mounting column 230. The gap 231 is stored between the end of the second objective lens clamping block 220 and the side wall of the first notch 13. The gap 231 can accommodate the side wall of the second notch 23. When the second objective lens 20 is mounted on the sight main body 10, the side wall of the second notch 23 is mounted in the gap 231, and the first notch 13 wraps the second notch 23. The above structure further enhances the stability of the mounting of the second objective lens.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A gun sighting device interacting with smart glasses, comprising:
a main body, the main body being provided with an aiming component for sighting and collecting data;
a first communication module, the first communication module being electrically connected to the aiming component and configured for transmitting data collected by the aiming component to the smart glasses.

2. The gun sighting device interacting with smart glasses according to claim 1, wherein the first communication module is a wireless communication module.

3. The gun sighting device interacting with smart glasses according to claim 2, wherein the wireless communication module comprises a first wireless communication module arranged on the main body, the first wireless communication module is electrically connected to the main body, and the first wireless communication module is configured for transmitting data collected by the aiming component to a second wireless communication module of the smart glasses.

4. The gun sighting device interacting with smart glasses according to claim 1, wherein the first communication module is a wired communication module.

5. The gun sighting device interacting with smart glasses according to claim 4, wherein the wired communication module is provided with a first connection end and a second connection end, the first connection end is electrically connected to the main body, and the second connection end is configured for being electrically connected to the smart glasses.

6. The gun sighting device interacting with smart glasses according to claim 5, wherein a first interface is provided on the main body, the first interface is electrically connected to the first connection end, and the second connection end is configured for being electrically connected to a second interface of the smart glasses.

7. The gun sighting device interacting with smart glasses according to claim 6, wherein the main body further comprises a sealing cover, the main body is provided with a connection port, and the sealing cover is configured for detachably covering the connection port.

8. The gun sighting device interacting with smart glasses according to claim 7, wherein the connection port is provided with a first slot and a second slot arranged side by side with the first slot, the first slot is provided with the first interface, the sealing cover is provided with a third connection end and a sealing end, the third connection end is connected to the second slot, and the sealing end is provided and covered on the first slot so as to seal the first slot.

9. The gun sighting device interacting with smart glasses according to claim 8, wherein a connection hole is defined in an inner wall of the second slot, the third connection end is provided with a connection rod, the connection rod is inserted into the connection hole, so that the sealing cover is connected to the main body.

10. The gun sighting device interacting with smart glasses according to claim 9, wherein the connection rod is provided with a plug-in end, the plug-in end is configured for inserting into the connection hole, and a clamping block is arranged between a top end of the plug-in end and a wall of the connection hole, and the clamping block is configured for clamping the plug-in end in the connection hole tightly, so that the sealing cover is in sealed connection with the main body, and, a diameter of the plug-in end gradually increases from its bottom end to its top end.

11. The gun sighting device interacting with smart glasses according to claim 10, wherein the sealing end is provided with a sealing portion for sealing the first slot, and at least one sealing gasket is further provided on an outer wall of the sealing portion.

12. The gun sighting device interacting with smart glasses according to claim 11, wherein an operating protrusion is provided on an outer surface of the sealing cover, and the operating protrusion is configured for driving the sealing portion to move when the operating protrusion is pulled by an external force, so that the sealing portion is released from the first slot.

13. The gun sighting device interacting with smart glasses according to claim 6, wherein the first wireless communication module is detachably connected to the first interface of the main body, and the first wireless communication module is electrically connected to the first interface of the main body.

14. The gun sighting device interacting with smart glasses according to claim 13, wherein the main body further comprises a first control box, the first control box is provided with a plug connector, the plug connector is electrically connected to the first interface, the first wireless communication module is arranged in the first control box, and the first wireless communication module is electrically connected to the plug connector.

15. The gun sighting device interacting with the smart glasses according to claim 14, wherein a power supply device is further arranged in the main body, and the power supply device is electrically connected to the first interface.

16. The gun sighting device interacting with smart glasses according to claim 13, wherein the sighting device further comprises smart glasses, a second control box is arranged on the smart glasses, the second wireless communication module is arranged in the second control box, and is in communication with the first wireless communication module.

17. The gun sighting device interacting with smart glasses according to claim 16, wherein the smart glasses further comprise a camera, a data processing module, a display module, a power supply module, and a touch module; the camera, the data processing module, the display module, and the touch module are all electrically connected to the power supply module; and the data processing module is configured for sending a sighting position and a target image received from the aiming component to the smart glasses, and the display module is configured for displaying the sighting position and the target image.

18. The gun sighting device interacting with smart glasses according to claim 1, wherein the aiming component comprises an objective lens assembly, the objective lens assembly comprises a first objective lens, a first end of the main body is provided with a first electrical connection board, a first end of the first objective lens is provided with a second electrical connection board, the first electrical connection board is electrically connected to the second electrical connection board, so that the first objective lens is electrically connected to the main body; the objective lens assembly further comprises a mounting frame, the mounting frame is provided with a plurality of through holes, a conductive contact is mounted in the through hole, two ends of the conductive contact are respectively abutted against the first electrical connection board and the second electrical connection board, so that the first electrical connection board is electrically connected to the second electrical connection board.

19. The gun sighting device interacting with smart glasses according to claim 18, wherein a first end of the main body is provided with a mounting portion, the mounting portion is provided with a housing, and a mounting slot is defined in and surrounded by an inner wall of the housing, a first end of the first objective lens is detachably arranged in the mounting slot, and a first waterproof gasket is arranged between the first objective lens and an inner wall of the mounting slot; a germanium window is further arranged in the mounting slot, and the germanium window is configured for preventing dust from entering a thermal imaging detector in the main body; and a second waterproof gasket is provided between the germanium window and a bottom end of the housing, and a limiting mounting member for positioning and attaching the mounting frame is further provided in the mounting slot.

20. The gun sighting device interacting with smart glasses according to claim 19, wherein an objective lens cover is also arranged and covered on the first objective lens, the objective lens cover comprises a sealed cover seat and a lens cover hinged on the sealed cover seat, the lens cover is sleeved at a first end of the first objective lens, and the sealed cover seat is provided with a hinge seat and a hinge portion, the hinge portion is arranged in the hinge seat, and is hinged by a hinge shaft.
